(19) United States
(12) Patent Application Publication
(10) Pub. No.: US 2022/0169141 A1
(43) Pub. Date: Jun. 2, 2022

(54) NOTIFICATION MANAGEMENT SYSTEMS AND METHODS FOR RESERVATION CHARGING OF ELECTRIC VEHICLE CHARGING STATION

(71) Applicant: Noodoe Corporation, Taipei City (TW)

(72) Inventors: Yi-An HOU, Taipei City (TW); Te-Chuan LIU, Taipei City (TW); Yan-Ming CHEN, Taipei City (TW); Wen-Nan CHEN, Taipei City (TW)

(21) Appl. No.: 17/412,337

(22) Filed: Aug. 26, 2021

(30) Foreign Application Priority Data
Nov. 30, 2020 (TW) 109142102

(51) Int. Cl. B60L 53/66; B60L 53/68; G06Q 10/02

(52) U.S. Cl. CPC B60L 53/665; G06Q 10/02; B60L 53/68

(57) ABSTRACT

A notification management method for reservation charging of electric vehicle charging station is provided. First, first electric vehicle is charged by an electric vehicle charging station set at a first geographic location. Then, a server is provided to record a reservation charging request for electric vehicle charging station, wherein reservation charging request is issued by a specific user corresponding to a second electric vehicle. The server receives a charging state of first electric vehicle from electric vehicle charging station via network and determines an estimated remaining charging time according to received charging state. The server receives a second geographic location of a mobile device corresponding to specific user via network. The server calculates a distance based on first geographic location and second geographic location, determines a notification time based on distance and estimated remaining charging time, and sends a notification message to mobile device,

### BACKGROUND OF THE INVENTION

### Field of the Invention

The disclosure relates generally to management systems and methods thereof, and, more particularly to management systems and methods that can perform related notification managements for reservation charging of electric vehicle charging station.

### Description of the Related Art

Recently, with the rising awareness of environmental protection and electric vehicle technology advances, the development of electric vehicles powered by electrical energy to replace traditional vehicles powered by fossil fuels has gradually become an important goal in the automotive field, thus making electric vehicles become more and more popular. In order to increase the range and willingness to use electric vehicles, many countries or cities have begun to set up charging stations in public places to provide electricity to electric vehicles, and have also begun to plan the deployment of a large number of charging stations in urban areas or scenic areas, so as to make the charging of electric vehicles more convenient.

Generally, users can guide to a specific charging point through navigation software to charge their electric vehicles. Based on the consideration of labor cost, charging points usually allow users of electric vehicles to charge the electric vehicles by themselves, and the number of charging stations set in the respective charging point is limited. Therefore, even if the user arrives at a specific charging point through navigation and is ready to charge the electric vehicle, it may be necessary to wait because the charging point is being used by other users.

Compared to traditional gasoline vehicles, electric vehicles take longer to charge. Therefore, when the charging station of the charging point is occupied, the user may need to queue to wait for charging. Some charging station operators also provide users of electric vehicles to make appointments for charging at specific charging stations through a dedicated application. Users can use an online queuing function of this application to wait for charging, and then go to the charging station for charging within a specified time after receiving a notification that it is their turn to charge, which can greatly reduce the time spent in queuing at the charging station, and also reduce the possibility of on-site traffic congestion due to queuing traffic. However, since the user cannot know when to go for charging, if the user is not notified in time, the user may be notified too late or unable to arrive in time due to other factors, resulting in a situation where the charging operation cannot be performed after an appointment. As a result, both charging station operators and users cannot achieve the best protection of rights and interests.

### BRIEF SUMMARY OF THE INVENTION

In the present invention, a server can perform the reservation charging management for an electric vehicle charging station, in which an appropriate notification time is determined based on the current charging operation state of the electric vehicle charging station and the location of a user who issued a charging reservation request for the electric vehicle charging station, and a notification message can be sent at the notification time to notify the user to go to the electric vehicle charging station for charging operations, thereby providing a more user-friendly notification service for reservation charging of electric vehicle charging station, thus enhancing a better charging experience for users.

An embodiment of a notification management system for reservation charging of electric vehicle charging station comprises an electric vehicle charging station, a mobile device, and a server. The electric vehicle charging station is set at a first geographic location. The electric vehicle charging station charges a first electric vehicle which is connected with the electric vehicle charging station. The mobile device is associated to a specific user of a second electric vehicle. The server records a reservation charging request for the electric vehicle charging station, wherein the reservation charging request is issued by the specific user corresponding to the second electric vehicle. The server receives a charging state of the first electric vehicle from the electric vehicle charging station via a network, and determines an estimated remaining charging time according to the received charging state. The server receives a second geographic location of the mobile device corresponding to the specific user via the network, calculates a distance based on the first geographic location and the second geographic location, and determines a notification time based on the distance and the estimated remaining charging time. The server sends a notification message to the mobile device via the network at the notification time.

In an embodiment of a notification management method for reservation charging of electric vehicle charging station, a first electric vehicle is charged by an electric vehicle charging station set at a first geographic location. Then, a server is provided to record a reservation charging request for the electric vehicle charging station, wherein the reservation charging request is issued by a specific user corresponding to a second electric vehicle. The server receives a charging state of the first electric vehicle from the electric vehicle charging station via a network and determines an estimated remaining charging time according to the received charging state. The server receives a second geographic location of a mobile device corresponding to the specific user via the network. The server calculates a distance based on the first geographic location and the second geographic location, determines a notification time based on the distance and the estimated remaining charging time, and sends a notification message to the mobile device via the network at the notification time.

In some embodiments, the server further obtains a traffic state between the first geographic location and the second geographic location, and determines the notification time according to the traffic state, the distance, and the estimated remaining charging time.

In some embodiments, the notification message comprises an estimated charging start time, which is calculated based on the estimated remaining charging time.

In some embodiments, the server further sets a grace period according to the estimated charging start time, instructs the electric vehicle charging station to only accept the confirmation of the specific user of the second electric vehicle, thus charging the second electric vehicle during the grace period, wherein the electric vehicle charging station can charge for any electric vehicle after the grace period.

In some embodiments, the notification message comprises a confirmation reply request, the mobile device further receives a confirmation input corresponding to the specific user after receiving the confirmation reply request, and sends a confirmation signal to the server based on the confirmation input, and the server sets the grace period in response to the confirmation signal.

In some embodiments, the notification message comprises a confirmation reply request, the mobile device further receives a cancellation input corresponding to the specific user or does not receive any input within a predetermined time after receiving the confirmation reply request, and sends a cancellation signal to the server, and the server cancels the reservation charging request corresponding to the second electric vehicle in response to the cancellation signal.

Notification management methods for reservation charging of electric vehicle charging station may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a notification management system for reservation charging of electric vehicle charging station of the invention;

FIG. 2 is a schematic diagram illustrating an embodiment of an electric vehicle charging station of the invention;

FIG. 3 is a schematic diagram illustrating an embodiment of a mobile device of the invention;

FIG. 4 is a schematic diagram illustrating an embodiment of a server of the invention;

FIG. 5 is a flowchart of an embodiment of a notification management method for reservation charging of electric vehicle charging station of the invention; and

FIG. 6 is a flowchart of another embodiment of a notification management method for reservation charging of electric vehicle charging station of the invention.

### DETAILED DESCRIPTION OF THE INVENTION

The following description is of the best-contemplated mode of carrying out the invention. This description is made for the purpose of illustrating the general principles of the invention and should not be taken in a limiting sense. It should be understood that the embodiments may be realized in software, hardware, firmware, or any combination thereof.

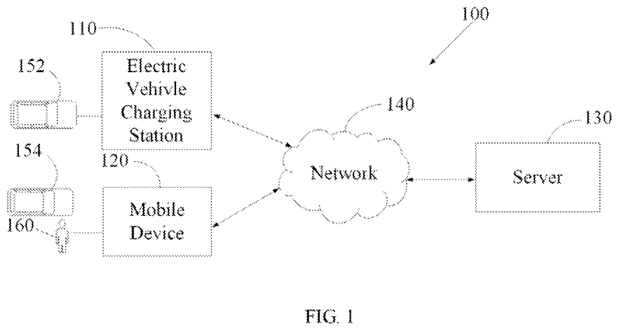

FIG. 1 is a schematic diagram illustrating an embodiment of a notification management system for reservation charging of electric vehicle charging station of the invention. As shown in FIG. 1, the notification management system for reservation charging of electric vehicle charging station 100 of the invention comprises at least one electric vehicle charging station 110, a mobile device 120, and a server 130. In some embodiments, the server 130 can connect to the mobile device 120, and the respective electric vehicle charging station 110 via a network 130, such as a wired network, a telecommunication network, and a wireless network, such as a Wi-Fi network or the like. The electric vehicle charging station 110 is set at a first geographic location and may have one or more charging devices. The electric vehicle charging station 110 can be connected with an electric vehicle 152, and perform a charging operation for the electric vehicle 152. The mobile device 120 can be any electronic device with Internet access and positioning capabilities, such as mobile phones, smart phones, personal digital assistants, global positioning systems, notebook computers, and in-vehicle devices. In one embodiment, a specific user 160 of the mobile device 120 can use the mobile device 120 to generate a charging request for the electric vehicle charging station 110. In another embodiment, when the specific user 160 is the owner of the electric vehicle 154 and the electric vehicle charging station 110 currently performs a charging operation for the electric vehicle 152, the specific user 160 can use the mobile device 120 to generate a reservation charging request for the electric vehicle charging station 110. That is, the specific user 160 can make an appointment to use the electric vehicle charging station 110 for charging the electric vehicle 154. The reservation charging request can be sent from the mobile device 120 of the specific user 160 corresponding to the electric vehicle 154 to the server 130 via the network 140. In some embodiments, the specific user 160 of the electric vehicle 154 can use the mobile device 120 to download and install an application from the server 130 via the network 140, and generate the reservation charging request via the user interface of the application.

The server 130 may record the location of the electric vehicle charging station 110 and the charging efficiency of one or more charging devices in the electric vehicle charging station 110. For example, the electric vehicle charging station 110 may be set in a first geographic location, such as a public parking lot, a shopping mall, a restaurant, a gas station, or a specific location, to provide corresponding electric vehicle charging services. It should be noted that the location of the aforementioned electric vehicle charging station 110 is only an example of this case, and the present invention is not limited to this. The electric vehicle charging station 110 can output electric power according to the charging efficiency to provide at least one electric vehicle 152 for charging operations. It is understood that, the charging efficiency of the electric vehicle charging station 110 can determine the charging time required for the electric vehicle 152. The charging efficiency may represent the maximum charging output power supported by the electric vehicle charging station 110 per hour. When the electric vehicle is charged at the electric vehicle charging station 110 with higher charging efficiency, the required charging time will be less. The electric vehicle charging station 110 has a network connection capability to receive, download or update various parameters and information required for charging management calculations. In an embodiment, the electric vehicle charging station 110 may provide one electric vehicle for charging at a time. In another embodiment, the electric vehicle charging station 110 can provide multiple electric vehicles for charging at the same time. The server 130 can connect to and communicate with the respective electric vehicle charging stations 110 through the network 140 to perform charging management operations for the electric vehicle charging stations 110. The server 130 can generate an instruction and send it to the electric vehicle charging station 110 through the network 140 to allow the electric vehicle charging station 110 to output power to an electric vehicle that is electrically connected to it, or to prohibit the electric vehicle charging station 110 from outputting power to the electric vehicle. For example, the server 130 may directly or indirectly receive a charging request from a mobile device of the corresponding electric vehicle 152, and after completing payment confirmation and other actions based on the charging request, the server 130 generates a charging authorization instruction and transmits it to the electric vehicle charging station 110 via the network 140. Accordingly, the station 110 allows the electric vehicle charging station 110 to output power to the electric vehicle 152 electrically connected to it or prohibits the electric vehicle charging station 110 from outputting power to the electric vehicle 152.

The server 120 can receive various data from the electric vehicle charging station 110 via the network 140. For example, when the electric vehicle 152 is connected to the electric vehicle charging station 110 through a charging gun of the electric vehicle charging station 110 for a charging operation, the electric vehicle charging station 110 can continuously transmit information of charging state corresponding to the charging operation of the electric vehicle 152 to the server 130 via the network 140. In some embodiments, the mobile device 120 can receive the charging state and notifications corresponding to the charging operation from the server 130 through the network 140. The notifications may be messages of notifying that the electric vehicle has stopped charging, notifying the moving, and notifying the charging gun of the electric vehicle charging station has been unplugged from the electric car and so on.

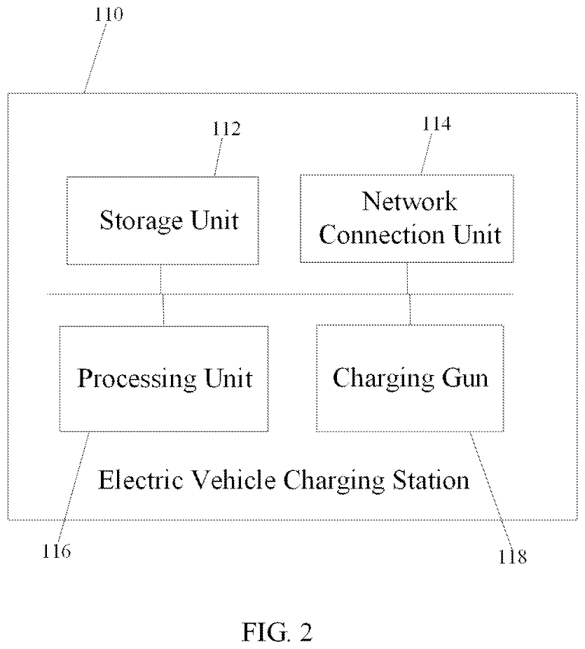

FIG. 2 is a schematic diagram illustrating an embodiment of an electric vehicle charging station of the invention. As shown in FIG. 2, the electric vehicle charging station 110 has processing and computing capabilities to perform charging management operations for the electric vehicle charging station 110. The electric vehicle charging station 110 has a network connection capability to receive, download or update various parameters and information required for charging management calculations.

The electric vehicle charging station 110 at least comprises a storage unit 112, a network connection unit 114, a processing unit 116, and a charging gun 118. The storage unit 112 may be a memory or a database for storing and recording related data, such as related information of the electric vehicle charging station and charging requests. It should be noted that the aforementioned information is only example, and the invention is not limited thereto. The network connection unit 114 can use a network, such as a wired network, a telecommunications network, and a wireless network, such as a Wi-Fi network, to receive, download, or update various parameters and information required for charging management operations. The processing unit 116 can control related operations of software and hardware in the electric vehicle charging station 110, and perform the notification management methods for reservation charging of electric vehicle charging station, which will be discussed later. For example, the processing unit 116 may be a general-purpose controller, a microcontroller (Micro-Control Unit, MCU), or a digital signal controller (Digital Signal Processor, DSP), etc., to provide data analysis, processing, and calculation operations. In one embodiment, when the electric vehicle 152 or the electric vehicle 154 is charged by the electric vehicle charging station 110, the processing unit 116 may use the network connection unit 114 to transmit the charging state of the corresponding charging operation to the server 130 via the network 140 for subsequent charging management. In another embodiment, the processing unit 116 may obtain the corresponding charging efficiency through the server 130, and charge the electric vehicle according to the charging efficiency. The charging gun 118 may include one or more charging connectors that have the same charging interface specification or have different charging interface specifications. The charging gun 118 is electrically connected to the electric vehicle, and outputs power to the electric vehicle at a specified charging efficiency according to the instruction of the processing unit 116.

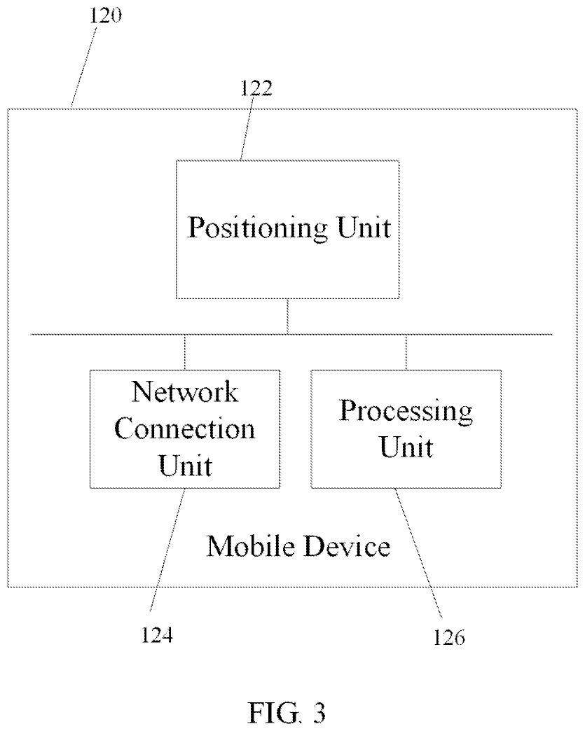

FIG. 3 is a schematic diagram illustrating an embodiment of a mobile device of the invention. As shown in FIG. 3, the mobile device 120 according to the embodiment of the present invention may be any electronic device with Internet access and positioning capabilities, such as mobile phones, smart phones, personal digital assistants, global positioning systems, notebook computers, and driving vehicles computers, vehicle-mounted devices, etc. The mobile device 120 comprises at least a positioning unit 122, a network connection unit 124, and a processing unit 126. The positioning unit 122 can communicate with at least one satellite to obtain the current position of the corresponding mobile device, such as latitude and longitude coordinates. The network connection unit 124 is used to transmit and receive messages through a network 140 such as a wired network, a telecommunication network, and a wireless network, such as a Wi-Fi network. The processing unit 126 can couple to the positioning unit 122 and the network connection unit 124, and control the related operations of software and hardware in the mobile device 120. The processing unit 126 can perform the notification management methods for reservation charging of electric vehicle charging station of the invention, which will be discussed later. For example, the processing unit 126 can be a general-purpose controller, a microcontroller (Micro-Control Unit, MCU), or a digital signal controller (Digital Signal Processor, DSP), etc., to provide data analysis, processing, and calculation functions.

In some embodiments, after the processing unit 126 receives a notification message including a confirmation reply request from the server 130 via the network connection unit 124, in response to the confirmation reply request, the processing unit 126 waits to receive a confirmation input from a specific user. It is noted that the processing unit 126 may continue to wait for receiving the input from the specific user for a predetermined period of time. The processing unit 126 determines whether a confirmation input corresponding to the specific user is received. When a confirmation input corresponding to the specific user is received within the predetermined period of time, it means that the specific user has confirmed and accepted the setting of the grace period, and the processing unit 126 sends a confirmation signal to the server 130 via the network connection unit 124 according to the confirmation input. When no input is received within the predetermined period of time, it means that the specific user has not confirmed or disagrees with the setting of the grace period, and the processing unit 126 sends a cancellation signal to the server 130 via the network connection unit 124. In some embodiments, a specific user can decide whether to cancel the scheduled charging through input. Therefore, the processing unit 126 can receive a cancellation input corresponding to the specific user, and after receiving the cancellation input corresponding to the specific user, The processing unit 126 may send a cancellation signal to the server 130 via the network.

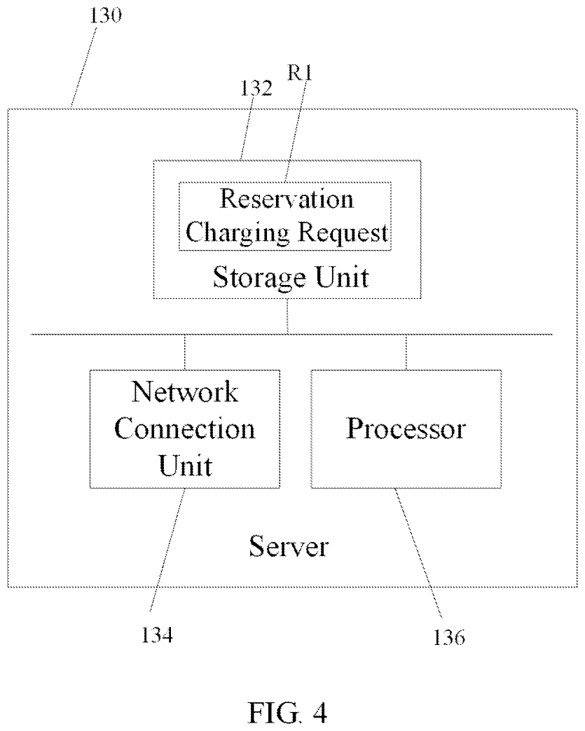

FIG. 4 is a schematic diagram illustrating an embodiment of a server of the invention. As shown in FIG. 4, the server 120 of the invention can be any processor-based electronic device, which comprises at least a storage unit 122, a network connection unit 124, and a processor 126. In an embodiment, the server 130 may be a charging management server. It is noted that the server 130 can perform the charging management operation of the corresponding electric vehicle charging station and the notification management operation of the reservation charging. The storage unit 132 may be a memory for storing and recording related data, such as specific user information corresponding to the electric vehicle (second electric vehicle), and second electric vehicle information corresponding to the reservation charging operation. The storage unit 132 may record the corresponding the setting positions (first geographic location) of the electric vehicle charging station 110 and the corresponding charging efficiency of the electric vehicle charging station 110. It is noted that, the electric vehicle charging station 110 can output electric power with the charging efficiency for charging at least one electric vehicle. The storage unit 132 may record the reservation charging request R1 for the electric vehicle charging station 110, wherein the reservation charging request R1 is issued by a specific user of the corresponding second electric vehicle. The network connection unit 134 can couple to the electric vehicle charging stations 110 through a network 140, such as a wired network, a telecommunication network, and a wireless network, such as a Wi-Fi network. With the network connection unit 134, the server 130 can be coupled to and communicate with the mobile device 120 through the network 140. The processor 136 can control the related operations of software and hardware in the server 130, and perform the notification management methods for reservation charging of electric vehicle charging station of the invention, which will be discussed later. For example, the processor 136 may be a general-purpose controller, a microcontroller (Micro-Control Unit, MCU), or a digital signal controller (Digital Signal Processor, DSP), etc., to provide data analysis, processing, and calculation functions. It is understood that, through the network connection unit 134, the server 130 can couple and communicate with the electric vehicle charging stations 110 through the network 140 to perform charging management operations for the electric vehicle charging stations 110. When the processor 136 performs the reservation charging operations, the server 130 can generate an instruction and send it to the electric vehicle charging station 110 through the network 140 to allow the electric vehicle charging station 110 to output power to an electric vehicle that is electrically connected to it or prohibit the electric vehicle charging station 110 from outputting electric power to the electric vehicle.

In some embodiments, the processor 136 may send a notification message comprising a confirmation reply request to the mobile device 120 through the network connection unit 134, and receive a confirmation signal or a cancellation signal corresponding to the confirmation reply request from the mobile device 120 through the network connection unit 134. Note that the confirmation signal indicates that the specific user has confirmed the setting of the grace period, and the cancellation signal indicates that the specific user has not confirmed or disagrees the setting of the grace period. After receiving the confirmation signal, the processor 136 sets a grace period corresponding to the confirmation signal. After receiving the cancellation signal, the processor 136 cancels the reservation charging request of the corresponding second electric vehicle in response to the cancellation signal.

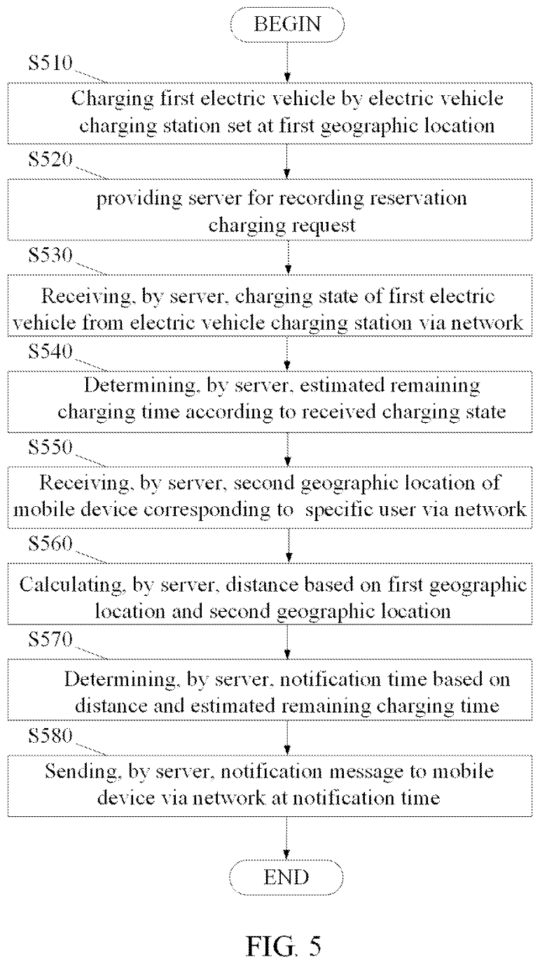

FIG. 5 is a flowchart of an embodiment of a notification management method for reservation charging of electric vehicle charging station of the invention. The notification management methods for reservation charging of electric vehicle charging station of the invention is applicable to at least one mobile device, an electric vehicle charging station, and a server, such as the electric vehicle charging station 110, the mobile device 120, and the server 130 in FIGS. 1, 2, 3, and 4.

In step S510, a first electric vehicle is charged via the electric vehicle charging station set at a first geographic location. Then, in step S520, a server is provided to record a reservation charging request for the electric vehicle charging station. The reservation charging request is issued by a specific user of a second electric vehicle. The server can connect to the electric vehicle charging station and the mobile device via a network, such as a wired network, a telecommunication network, and a wireless network, such as a Wi-Fi network, etc. In an embodiment, the server may be a charging management server for performing charging managements for the electric vehicle charging station. Specifically, when the specific user is the owner of the second electric vehicle, and the electric vehicle charging station currently performs a charging operation for the first electric vehicle, the specific user can generate the reservation charging request to the electric vehicle charging station by using the mobile device, thus to make an appointment to use the electric vehicle charging station for charging the second electric vehicle. In step S530, the server receives a charging state corresponding to the first electric vehicle from the electric vehicle charging station via the network. In step S540, the server determines an estimated remaining charging time according to the received charging state. In some embodiments, when the first electric vehicle is coupled to the electric vehicle charging station through a charging gun of the electric vehicle charging station for a charging operation, the electric vehicle charging station can continuously transmit the charging state corresponding to the charging operation of the first electric vehicle to the server via the network. The server may determine an estimated remaining charging time of the first electric vehicle according to the received charging state. For example, when it takes about 2 hours for the first electric vehicle to be fully charged from completely empty, and the charging state of the first electric vehicle indicates that there is half of the remaining power, the server can determine the estimated remaining time for charging the first electric vehicle is about 1 hour. In step S550, the server receives a second geographic location of the mobile device corresponding to the specific user through the network. Note that the mobile device may comprise a positioning unit that can communicate with at least one satellite to obtain the second geographic location of the mobile device, such as latitude and longitude coordinates, and send the second geographic location to the server via the network. After obtaining the first geographic location and the second geographic location, in step S560, the server calculates a distance according to the first geographic location and the second geographic location. In this step, the server can calculate the distance from the second geographic location where the mobile device of the specific user is located to the first geographic location where the electric vehicle charging station is located, thereby estimating the time required for the second electric vehicle to reach the electric vehicle charging station. In step S570, the server determines a notification time based on the distance and the estimated remaining charging time. As mentioned above, the server may calculate the distance based on the second geographic location and the first geographic location, and estimate a first estimated time based on the distance.

The aforementioned estimated remaining time for charging is a second estimated time. The server may use the first estimated time and the second estimated time to determine the notification time. For example, in one embodiment, when the first estimated time is greater than the second estimated time, the notification time is determined according to the first estimated time, and when the first estimated time is less than or equal to the second estimated time, the notification time is determined according to the second estimated time. In another embodiment, the notification time can be determined by the sum of the first estimated time with a first weighting and the second estimated time with a second weighting, wherein the sum of the first weighting and the second weighting is less than or equal to 1. In step S580, the server sends a notification message to the mobile device via the network at the notification time. In some embodiments, the notification message may comprise an estimated charging start time calculated based on the estimated remaining charging time. Specifically, the server can estimate the completion time of the charging operation based on the estimated remaining time of the charging operation currently performed for the first electric vehicle, so as to calculate the estimated charging start time of the next charging operation for the second electric vehicle. Assuming that the estimated charging start time of the second electric vehicle of the corresponding specific user is 2 pm, the server can first determine the notification time as 1:30 pm based on the distance and the estimated remaining charging time, and send the notification message comprising the estimated starting charging time to the mobile device of the specific user at 1:30 pm via the network, so that the specific user can know the time to go to the electric vehicle charging station. The notification message can be a text message, for example “Dear sir, please go to the electric vehicle charging station and start charging before 2 pm, otherwise the reservation will be cancelled. Thank you”.

In some embodiments, the traffic state between the location of the electric vehicle charging station and the location of the next reserved user may affect the time when the next reserved user actually arrives at the electric vehicle charging station. The server can obtain a traffic state between the first geographic location of the electric vehicle charging station and the second geographic location of the mobile device of the specific user, and determine the notification time according to the traffic state, distance, and estimated remaining charging time. For example, when the traffic state is good, the notification time does not need to be adjusted, and when the traffic state indicates traffic jam, the notification time can be adjusted accordingly, so as to notify the next reserved user in advance, so as to prevent the next reserved user from being unable to arrive at the electric vehicle charging station on time within the estimated charging start time. For example, assuming that the estimated charging start time of the second electric vehicle is 2 pm, the server can first determine the notification time as 1:30 pm based on the distance and the estimated remaining charging time. When factors such as traffic jam have been predicted in advance that the second electric vehicle will take more time to reach the electric vehicle charging station, the server can adjust the notification time to 1 pm. It is noted that the aforementioned notification time and adjustment are only examples, and the present invention is not limited thereto.

In some embodiments, the server may set a grace period according to the estimated charging start time, and the electric vehicle charging station can only accept the confirmation of the specific user of the second electric vehicle during the grace period, so as to perform the charging operation for the second electric vehicle. After the grace period, the electric vehicle charging station can accept the charging request from any electric vehicle. In other words, during the grace period, the electric vehicle charging station will be reserved for use by the second electric vehicle, and the second electric vehicle has the priority to use the electric vehicle charging station, and other electric vehicles cannot occupy it. After the grace period, other electric vehicles can have the right to use the electric vehicle charging station. In one embodiment, the server can further perform the charging reservation operation of the electric vehicle charging station for the second electric vehicle. For example, the server can set the state of the electric vehicle charging station during the grace period to the in-use or unusable state, and only allow the second electric vehicle to use the electric vehicle charging station. That is other electric vehicles cannot request to use the electric vehicle charging station for charging. For example, assuming that the estimated charging start time of the second electric vehicle is 2 pm and the grace period is set to 15 minutes. When the second electric vehicle arrives at the electric vehicle charging station before 2:15 pm and the server receives the confirmation from the specific user of the second electric vehicle, the electric vehicle charging station starts to charge the second electric vehicle. Conversely, when the second electric vehicle does not arrive at the electric vehicle charging station at 2:15 pm, the server can cancel the reservation charging request corresponding to the specific user of the second electric vehicle. The state of the electric vehicle charging station is reset to the available state, so users of other electric vehicles can request to use this electric vehicle charging station for charging. In some embodiments, the electric vehicle charging station may have multiple reservation charging requests, and the server has a charging queue, which records the reservation charging requests according to the order in which the requests are issued. When the reservation charging request of the specific user is cancelled, the server can select one of the next in line, and calculate a second distance according to the third geographic location of the mobile device of a substitute user and the first geographic location of the electric vehicle charging station, so as to estimate the time required for the third electric vehicle of the substitute user to reach the electric vehicle charging station, and calculate an estimated charging start time of the third electric vehicle. Then, a notification time is determined according to the second distance and the estimated charging start time, and a notification message is sent to the mobile device of the substitute user via the network at the notification time.

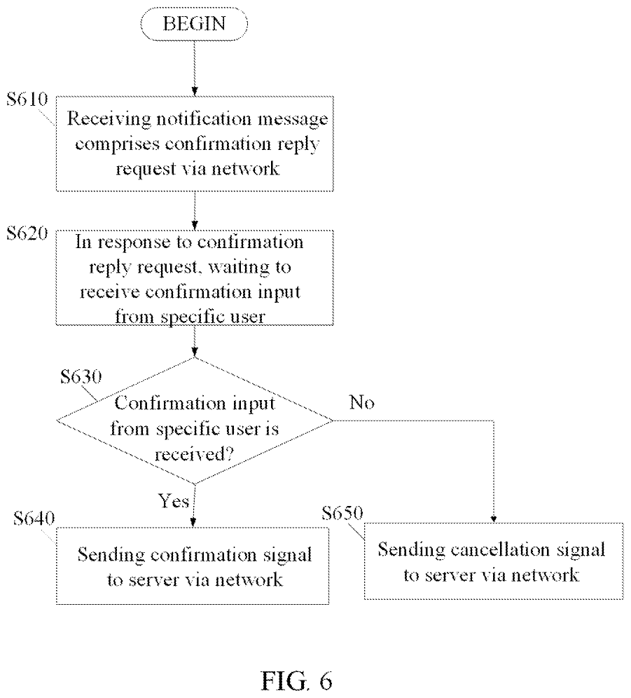

FIG. 6 is a flowchart of another embodiment of a notification management method for reservation charging of electric vehicle charging station of the invention. The notification management methods for reservation charging of electric vehicle charging station of the invention is applicable to at least one mobile device, such as the mobile device 120 in FIGS. 1, and 3. The mobile device can connect to a server through a network, such as a wired network, a telecommunication network, and a wireless network, such as a Wi-Fi network. In this embodiment, the server can set a grace period according to the estimated charging start time, and the notification message may comprise a confirmation reply request to request the user to confirm the grace period.

In step S610, the mobile device receives a notification message comprising a confirmation reply request from the server via the network. After the mobile device receives the confirmation reply request, in step S620, in response to the confirmation reply request, the mobile device waits to receive a confirmation input. Note that the mobile device can continue to wait for input from a specific user for a predetermined period of time. In step S630, the mobile device determines whether a confirmation input corresponding to a specific user is received. If a confirmation input corresponding to the specific user is received within the predetermined period of time (Yes in step S630), it means that the specific user has confirmed the setting of the grace period, and in step S640, in response to the confirmation input, the mobile device sends a confirmation signal to the server via the network, and the server sets the grace period in response to the confirmation signal. If no input is received within a predetermined period of time (No in step S630), it means that the specific user has not confirmed or disagrees with the setting of the grace period, and in step S650, the mobile device sends a cancellation signal to server. In some embodiments, the specific user can choose to cancel the reservation charging request through input, so the mobile device can further receive a cancellation input from the specific user. After receiving the cancellation input from the specific user, the mobile device can send a cancellation signal to the server via the network. After the server receives the cancellation signal, the server cancels the reservation charging request of the second electric vehicle in response to the cancellation signal.

Therefore, the notification management systems and methods for reservation charging of electric vehicle charging station of the present invention can perform the reservation charging managements for electric vehicle charging stations. The server can determine an appropriate notification time according to the current charging state of the electric vehicle charging station and the location of a user who issued a charging reservation request for the electric vehicle charging station, and a notification message can be sent at the notification time to notify the user to go to the electric vehicle charging station for charging operations, thereby providing a more user-friendly notification service for reservation charging of electric vehicle charging station, thus enhancing a better charging experience for users.

Notification management methods for reservation charging of electric vehicle charging station, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for executing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for executing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalent.

What is claimed is:

1. A notification management system for reservation charging of electric vehicle charging station, comprising:
an electric vehicle charging station set at a first geographic location for connecting with a first electric vehicle, and charging the first electric vehicle;
a mobile device associated to a specific user of a second electric vehicle; and
a server recording a reservation charging request for the electric vehicle charging station, wherein the reservation charging request is issued by the specific user corresponding to the second electric vehicle, receiving a charging state of the first electric vehicle from the electric vehicle charging station via a network, determining an estimated remaining charging time according to the received charging state, receiving a second geographic location of the mobile device corresponding to the specific user via the network, calculating a distance based on the first geographic location and the second geographic location, determining a notification time based on the distance and the estimated remaining charging time, and sending a notification message to the mobile device via the network at the notification time.

2. The system of claim 1, wherein the server further obtains a traffic state between the first geographic location and the second geographic location, and determines the notification time according to the traffic state, the distance, and the estimated remaining charging time.

3. The system of claim 1, wherein the notification message comprises an estimated charging start time, which is calculated based on the estimated remaining charging time.

4. The system of claim 3, wherein the server further sets a grace period according to the estimated charging start time, instructs the electric vehicle charging station to only accept the confirmation of the specific user of the second electric vehicle, thus charging the second electric vehicle during the grace period, wherein the electric vehicle charging station can charge for any electric vehicle after the grace period.

5. The system of claim 4, wherein the notification message comprises a confirmation reply request, the mobile device further receives a confirmation input corresponding to the specific user after receiving the confirmation reply request, and sends a confirmation signal to the server based on the confirmation input, and the server sets the grace period in response to the confirmation signal.

6. The system of claim 5, wherein the notification message comprises a confirmation reply request, the mobile device further receives a cancellation input corresponding to the specific user or does not receive any input within a predetermined time after receiving the confirmation reply request, and sends a cancellation signal to the server, and the server cancels the reservation charging request corresponding to the second electric vehicle in response to the cancellation signal.

7. A notification management method for reservation charging of electric vehicle charging station, comprising:
charging a first electric vehicle by an electric vehicle charging station set at a first geographic location;
providing a server for recording a reservation charging request for the electric vehicle charging station, wherein the reservation charging request is issued by a specific user corresponding to a second electric vehicle;
receiving, by the server, a charging state of the first electric vehicle from the electric vehicle charging station via a network;
determining, by the server, an estimated remaining charging time according to the received charging state;
receiving, by the server, a second geographic location of a mobile device corresponding to the specific user via the network;
calculating, by the server, a distance based on the first geographic location and the second geographic location;
determining, by the server, a notification time based on the distance and the estimated remaining charging time; and
sending, by the server, a notification message to the mobile device via the network at the notification time.

8. The method of claim 7, further comprising:
obtaining, by the server, a traffic state between the first geographic location and the second geographic location; and
determining, by the server, the notification time according to the traffic state, the distance, and the estimated remaining charging time.

9. The method of claim 7, further comprising:
setting, by the server, a grace period according to the estimated remaining charging time; and
instructing, by the server, the electric vehicle charging station to only accept the confirmation of the specific user of the second electric vehicle, thus charging the second electric vehicle during the grace period,
wherein the electric vehicle charging station can charge for any electric vehicle after the grace period.

10. The method of claim 9, wherein the notification message comprises a confirmation reply request, and the method further comprises the steps of:
receiving, by the mobile device, a confirmation input corresponding to the specific user after receiving the confirmation reply request;
sending, by the mobile device, a confirmation signal to the server based on the confirmation input; and
setting, by the server, the grace period in response to the confirmation signal.
